(19) United States
(12) Patent Application Publication
(10) Pub. No.: US 2014/0333501 A1
(43) Pub. Date: Nov. 13, 2014

(54) ULTRABROADBAND ANTENNA

(71) Applicant: ALCATEL LUCENT, Paris (FR)

(72) Inventors: Sebastien Chainon, Lannion (FR); Nicolas Cojean, Lannion (FR); Gilles Raoul, Lannion (FR)

(73) Assignee: ALCATEL LUCENT, Paris (FR)

(21) Appl. No.: 14/345,555

(22) PCT Filed: Sep. 19, 2012
(86) PCT No.: PCT/EP2012/068432

§ 371 Date: Mar. 18, 2014

(30) Foreign Application Priority Data
Sep. 22, 2011 (FR) 1158459

(51) Int. Cl. H01Q 5/00; H01Q 21/00; H01Q 19/10

(52) U.S. Cl. CPC H01Q 5/0062; H01Q 19/10; H01Q 21/00
USPC 343/833

(57) ABSTRACT

An antenna, intended to transmit and receive radio waves within a given frequency band, comprises at least one radiating element, placed on a flat reflector, comprising a radiating device disposed within a plane parallel to the reflector's plane, at least one conductive line feeding the radiating element, at least one parasitic element disposed above the radiating element, which comprises a two-dimensional base belonging to a plane parallel to the radiating device's plan, associated with a third dimension that gives it a volumic shape.

### CROSS-REFERENCE

This application is based on French Patent Application #11,58,459 filed on Sep. 22, 2010, the disclosure of which is hereby incorporated by reference thereto in its entirety, and the priority of which is hereby claimed under 35 U.S.C. §119.

### BACKGROUND

The present invention pertains to an antenna that operates within a very broad frequency band.

The base station antennas are currently designed for applications that cover a frequency domain that ranges from GSM to DCS/PCS and UMTS. However, many services are currently emerging, like LTE (for “Long-Term Evolution”) for 700 MHz and 2600 MHz frequencies. Clients' requirements are changing accordingly in order to benefit not only from existing services but also from new services arriving on the market. Furthermore, today manufacturing costs and visual pollution must be fully integrated into the design of base station antennas. In order to meet clients' requirements, there is a need for an antenna that covers all operating frequencies and that allows OEMs and carriers to access all services with minimal visual pollution and minimal restrictions on base station systems. Such antennas that use the frequency band that covers the domains from 700 MHz to 960 MHz and/or from 1710 MHz to 2700 MHz are called “ultrabroadband antennas.”

The main restriction with respect to ultrabroadband antennas is the value of the bandwidth for covering the domain from 1710 MHz-2700 MHz, for example. The bandwidth Δf of the antenna is defined by the relationship Δf=(fₘₐₓ−fₘᵢₙ)/f₀ where fₘₐₓ is the antenna's maximum operating frequency, fₘᵢₙ is the antenna's minimum operating frequency, and f₀ is the central operating frequency. The bandwidth Δf may typically range from 30% to 50%, for example 600 MHz to 1000 MHz for a central frequency f₀ of 2 GHz. However, the value of the bandwidth is not the only restriction to meet.

Rather, in order to limit its impact on base station systems, the antenna must have significant stability in its RF radiofrequency performance depending on the frequency band that is used. Typically, the [S] parameters (for “Scattering parameters”), which are the distribution coefficients for the power injected into the antenna, and the radiation pattern should have the lowest possible frequency band variation. This is a technical problem that has proven very difficult for base station antenna manufacturers to solve.

To ensure the stability of the [S] parameters and the radiation performance, the solution currently proposed by base station antenna manufacturers is to use a broadband radiating element associated with a reflector with a specially designed shape, such as a flat reflector that comprises side walls, a parabolic reflector, etc. . . . The most commonly used radiating elements are superimposed dipoles or flat radiating elements (called “patches”). The use of this sort of radiating element with a specially shaped reflector makes it possible to meet broadband specifications in terms of impedance and radiation performance. However, this solution exhibits limitations with respect to [S] parameters and radiation performance, and cannot be used for ultra-broadband applications.

### SUMMARY

The purpose of the present invention is to propose a solution that improves stability of an RF antenna's overall performance, in particular when the bandwidth has a large width.

A particular purpose of the invention is to propose an ultra-broadband antenna makes it possible to obtain a stable beamwidth of 3 dB, much higher than what has been observed for antennas of the prior art.

The object of the present invention is an antenna intended to transmit and receive radio waves within a given frequency band, comprising
at least one radiating element placed on a flat reflector comprising a radiating device disposed within a plane parallel to the plane of the reflector,
at least one conductive line feeding the radiating element, and
at least one conductive parasitic element disposed above the radiating element.

The parasitic element comprises a two-dimensional base belonging to a plane parallel to the plane of the radiating device, associated with a third dimension that gives it a volumic shape.

Here, the term parasitic element refers to a conductive element, disposed above a radiating device, which is not fed, neither directly, nor indirectly, by way of the radiating device. It is often designated by the term “director”. The addition of three-dimensional (3D) parasitic elements above the dipoles makes it possible to expand the frequency band, and to maintain the stability of the radiation performance across the entire bandwidth.

According to a first embodiment, the parasitic element is shaped like a truncated pyramid with a square base and a truncated peak.

According to a second embodiment, the parasitic element is composed of four three-dimensional wings that form truncated-pyramid sectors, at an angle of between 30° and 60° inclusive, connected at their tip, the four wings defining a square base and a truncated peak.

According to a third embodiment, the parasitic element is formed of four wings each having roughly the shape of a clipped right triangle, which meet at right angles, with the cross-shaped base being defined by the long sides of the right triangles and the peak by the clipped angles.

According to one implementation, the side length of the base is about 0.2 λₘᵢₙ, where λₘᵢₙ is the wavelength of the lowest frequency of the frequency band.

According to another implementation, the length of the peak's side is about 0.2 λₘₐₓ, where λₘₐₓ is the wavelength of the highest frequency of the frequency band.

According to a fourth embodiment, the parasitic element is shaped like a rounded cone supported by a cylinder.

According to one implementation, the diameter of the circular base is about 0.2 λₘᵢₙ, where λₘᵢₙ is the wavelength of the lowest frequency of the frequency band.

According to one aspect, the total height of the parasitic element is between 0.05 λ₀ and 0.25 λ₀ inclusive, where λ₀ is the wavelength at the central operating frequency.

According to another aspect, the distance separating the plane of the parasitic element's base from the plane of the radiating device is about 0.2 λ₀, where λ₀ is the wavelength of the frequency band's central frequency.

The present invention has the advantage of beam stability across the entire frequency band, expanded bandwidth, and improved overall radiation performance, in particular the 3 dB beamwidth and cross-polarization at 0° and ±60°.

### BRIEF DESCRIPTION

Other characteristics and advantages of the present invention will become apparent upon reading the following description of one embodiment, which is naturally given by way of a non-limiting example, and in the attached drawing, in which:

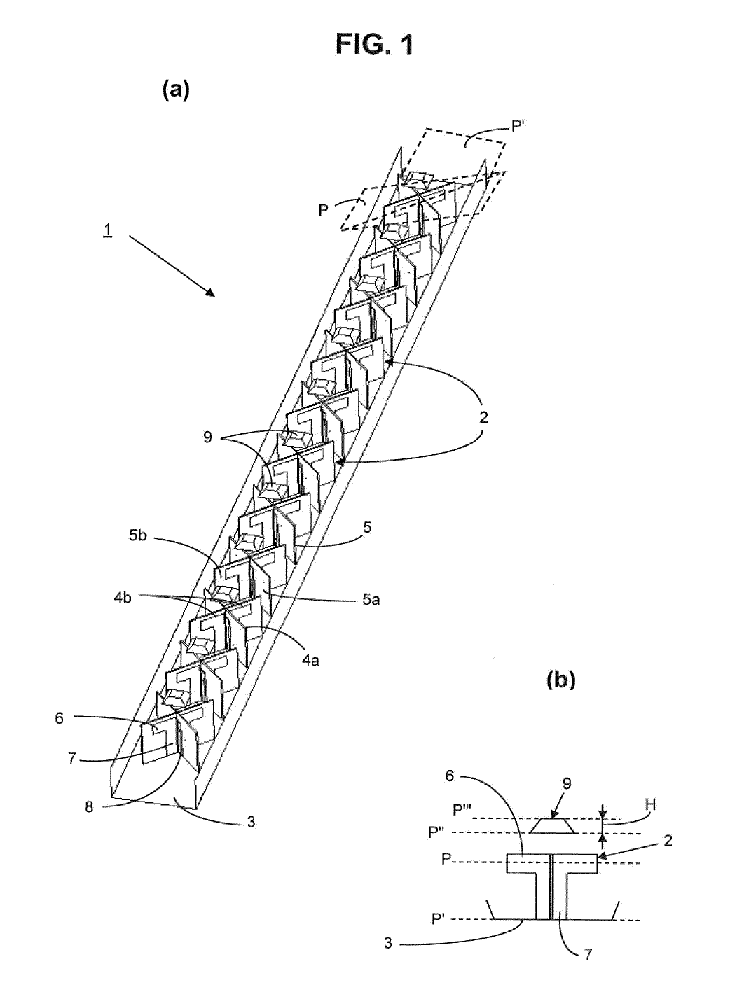

FIGS. 1a and 1b illustrate an ultra-broadband antenna according to a first variant of a first embodiment,

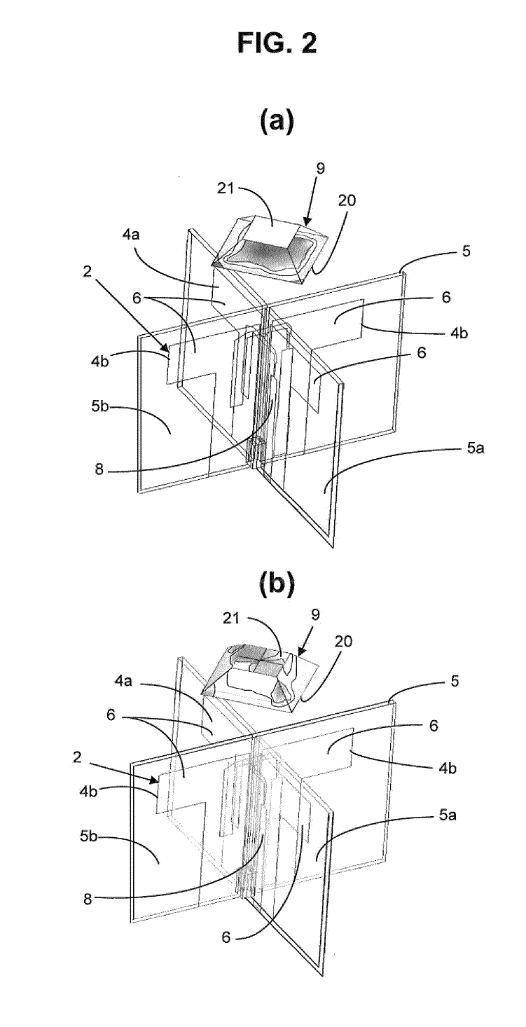

FIGS. 2a and 2b illustrate the distribution of current based on the frequency band in the case of the antenna of FIG. 1,

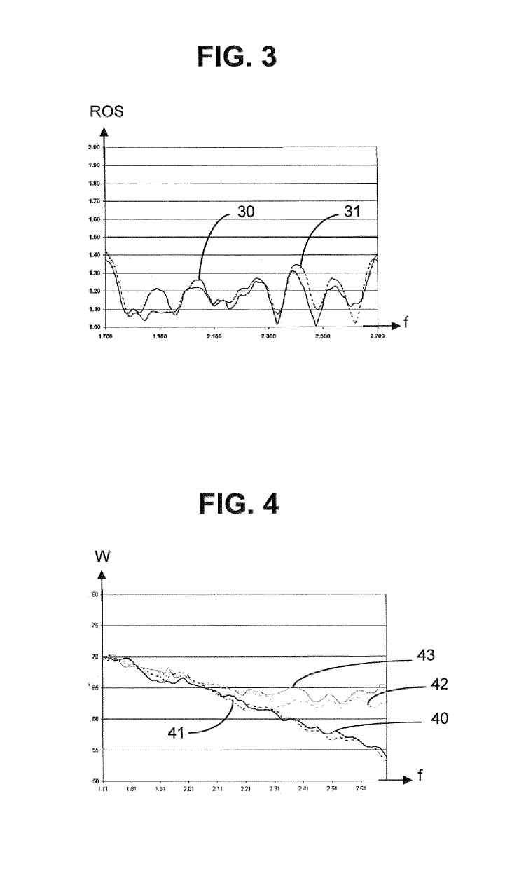

FIG. 3 illustrates the voltage standing wave ratio ROS as a function of the frequency f,

FIG. 4 illustrates the variation of the width W of the beam in the horizontal plane, equal to −3 dB, as a function of the frequency f,

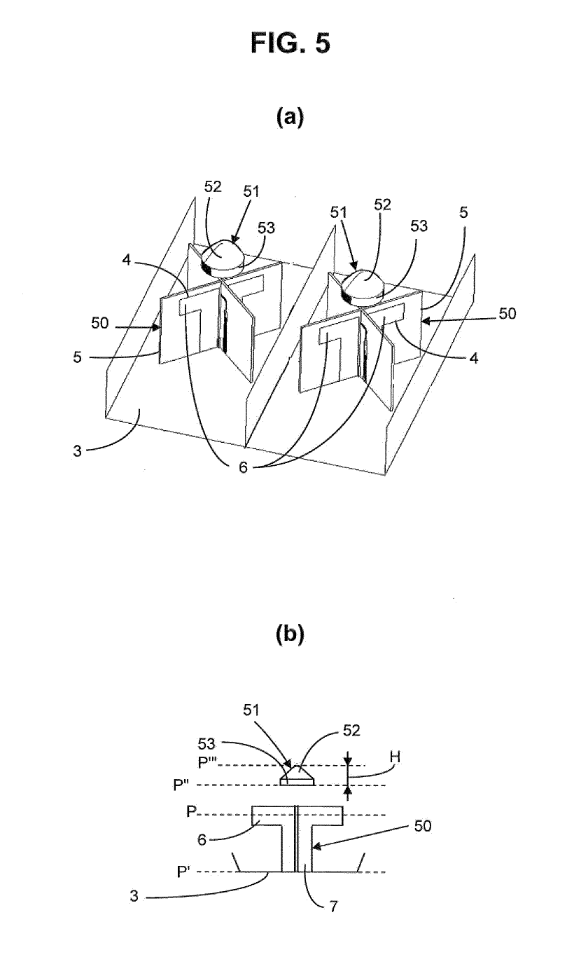

FIGS. 5a and 5b illustrate an antenna according to a second variant of the first embodiment,

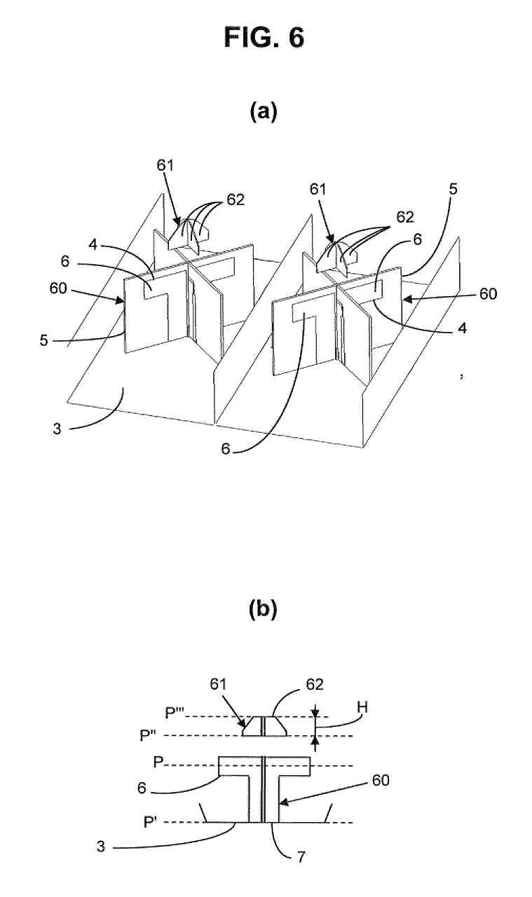

FIGS. 6a and 6b illustrate an antenna according to a third variant of the first embodiment,

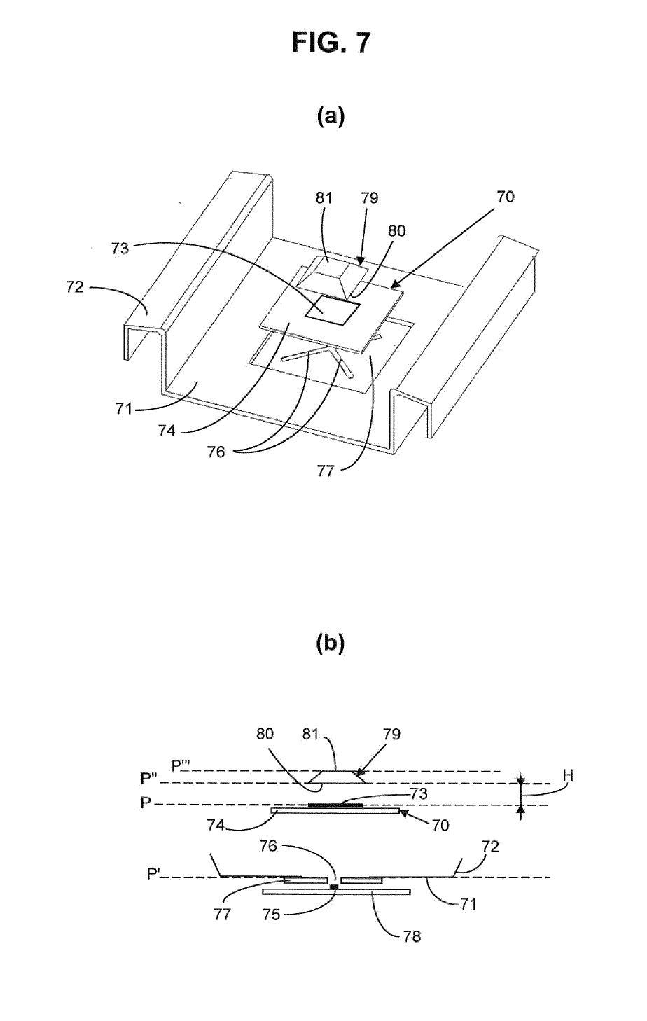

FIGS. 7a and 7b illustrate an antenna according to a second embodiment,

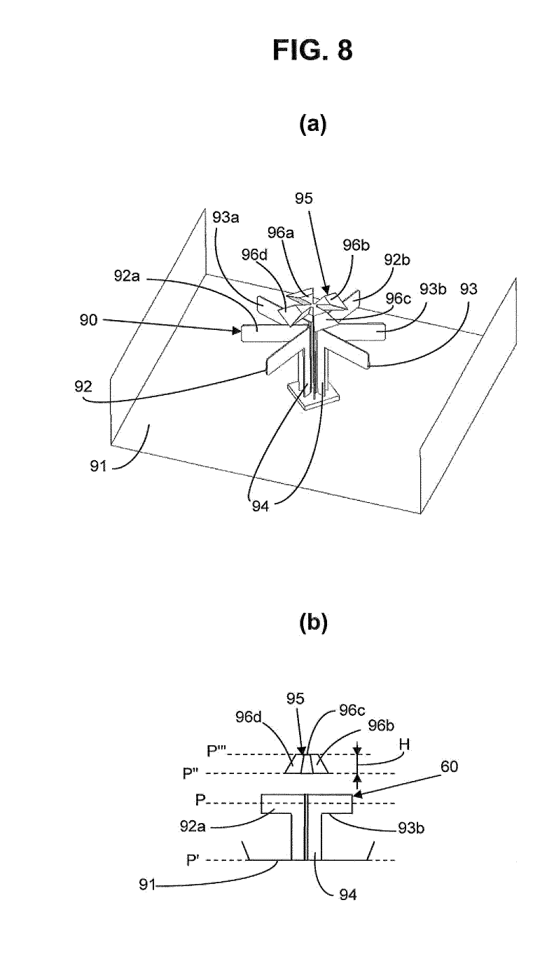

FIGS. 8a and 8b illustrate an antenna according to a third embodiment.

Identical elements in each of these figures have the same reference numbers.

### DETAILED DESCRIPTION

An antenna 1, comprising radiating elements 2, according to a first embodiment of the invention, is illustrated in FIGS. 1a and 1b. FIG. 1a is a perspective view of the antenna 1, and FIG. 1b is a schematic cross-section view showing how the planes are superimposed.

The radiating elements 2 are aligned and supported by a reflector 3 that is flat and equipped with side walls. The radiating element 2 comprises two orthogonal cross-polarization half-wave dipoles 4a, 4b, obtained by duplicating a single dipole by rotating it 90°. The dipoles 4a, 4b are printed onto a substrate 5 made up of two orthogonal planes 5a, 5b. The substrate 5 is made of a material with a high dielectric constant εᵣ (1<εᵣ<5), such as a glass and Teflon plate with the product code “TLX-08” from the company “TACONIC”. The intersection of the dipoles 4a, 4b in their respective slots coincides with the intersection of the orthogonal planes 5a, 5b of the substrate 5. Each dipole 4a, 4b, of a “stripline” type, printed on both sides of the substrate 5, comprises two co-linear conductive arms 6 supported by a base 7. The arms 6 of the dipoles 4a, 4b constitute a radiating device disposed within a plane P parallel to the plane P′ of the reflector 3 as is shown schematically in FIG. 1b. The arms 6 and the base 7 are printed on the same side of one of the orthogonal planes 5a, 5b of the dielectric substrate 5. The arms 6 extend in a direction parallel to the plane of the reflector 3. The dipoles 4a, 4b are fed by a conductive line 8, printed on the opposite side of one of the orthogonal planes 5a, 5b of the dielectric substrate 5, and connected to a balun, not shown here.

A parasitic element 9, or director, is placed above the radiating element 2 parallel to the arms 6 of the dipoles 4a, 4b as shown in FIG. 1b. The parasitic element 9 is conductive, for example made of metal. The parasitic element 9 comprises a base and a third dimension that gives it density properties. The base is two-dimensional, associated with both polarizations, and contained within a plane “P” parallel to the plane P of the radiating device constituted by the arms 6 of the dipoles 4a, 4b as shown schematically in FIG. 1b. In a first variant, the parasitic elements 9 have a truncated pyramid shape.

FIGS. 2a and 2b illustrate the distribution of current based on the frequency band showing the part of the pyramid in question based on the frequency. On the lower-frequency end of the frequency band, the distribution of current is depicted in FIG. 2a. The assembly, made up of the radiating element 2 and the pyramidal parasitic element, 9 behave from a radiofrequency viewpoint as though the parasitic element 9 were reduced to a two-dimensional surface represented by the pyramid's square base 20 where most of the current is located. The base 20 is located in a plane P″ parallel to the plane P of the radiating device represented by the arms 6 of the dipoles 4a, 4b. At the other, higher-frequency end of the frequency band, the distribution of current is depicted in FIG. 2b. The assembly, made up of the radiating element 2 and the pyramidal parasitic element 9, also behaves as though the parasitic element 9 were reduced to a two-dimensional surface, but in this case that surface is the truncated peak 21 of the pyramid. The truncated peak 21 is contained within a plane P″′ parallel to the plane P of the radiating device, here constituted by the arms 6 of the dipoles 4a, 4b. The truncated pyramid shape makes it possible to connect these two surfaces in order to obtain improved broadband performance in terms of impedance and radiation. The truncated peak 21 is located within a plane P″′ parallel to the plane P of the radiating device, represented by the arms 6 of the dipoles 4a, 4b.

The size of the parasitic element 9 is determined by the frequency band sought for the antenna's operation. The dimensions of the square base 20 depend directly on the lowest frequency fₘᵢₙ of the frequency band in question. The truncated peak 21 of the pyramid-shaped parasitic element 9 depends on the highest frequency fₘₐₓ of the frequency band. However, it should be noted that even if the truncated peak 21 has a low radio influence near the bottom of the frequency band and the radio influence of the square base 20 is low near the top of the frequency band, the entire volume of the three-dimensional (3D) parasitic element 9 contributes to the radio behavior of the antenna 1 and the achievement of its performance. In this variant, the side length of the square base 20 is about 0.2 λₘᵢₙ where λₘᵢₙ is the wavelength of the frequency band's lowest frequency fₘᵢₙ. The length of the side of the truncated peak 21 is about 0.2 λₘₐₓ where λₘₐₓ is the wavelength of the highest frequency fₘₐₓ of the frequency band. The height H of the truncated pyramid-shaped parasitic element 9 is between 0.05 λ₀ and 0.25 λ₀, where λ₀ is the wavelength at the central operating frequency f₀.

The distance between the plane P of the radiating device and the plane P″ of the base 20 of the parasitic element 9 is about 0.2 λ₀ where λ₀ is the wavelength of the central frequency f₀ of the frequency band.

FIG. 3 illustrates the voltage standing wave ratio ROS (or “VSWR”) on the y-axis, as a function of the frequency ν in GHz on the x-axis. The curves 30 and 31 are obtained with the antenna of FIG. 1 comprising 3D parasitic elements, for the two ports +45° and −45° respectively.

Combining the radiating element with a 3D parasitic element makes it possible to obtain broadband impedance operating with a voltage standing wave ratio ROS less than 1.5 for an application in the bandwidth range 1.7-2.7 GHz (45% of the frequency band).

FIG. 4 is an illustration of the variation in the width W of the beam in the horizontal plane, equal to −3 dB, given in degrees on the y-axis, as a function of frequency f in GHz on the x-axis. The curves 40 and 41 are obtained with an antenna of the prior art that does not comprise a 3D-volumic parasitic element, but which does, for example, comprise a 2D-flat parasitic element. A flat parasitic element is a parasitic element whose two dimensions are much greater than the third, the third dimension being negligible, for example a parasitic element printed on a substrate. The curves 40 and 41 are given for the 2 ports +45° and −45° respectively, and for a tilt of zero. The curves 42 and 43 are obtained with the antenna of FIG. 1 comprising 3D-volumic parasitic elements, for the two ports +45° and −45° respectively, and for a tilt of zero.

Comparing the curves 40 and 42 and the curves 41 and 43 shows that the −3 dB width W of the antenna's beam is very different between the two antennas for the highest frequencies of the frequency band. The antenna of FIG. 1 comprising 3D-volumic parasitic elements has a stable beamwidth, particularly in the domain of high frequencies, which is much greater than that which is observed for an antenna of the prior art. The improvement of cross-polarization at 0° and ±60 must also be pointed out.

A second variant of this first embodiment is illustrated by FIGS. 5a and 5b. FIG. 5a is a perspective view and FIG. 5b is a schematic cross-section view depicting how the planes overlap.

A radiating element 50 comprises dipoles 4 printed on a substrate 5 as described above. The arms 6 of the dipoles 4 constitute a radiating device disposed within a plane P parallel to the plane P′ of the reflector 3 as is shown schematically in FIG. 5b.

A parasitic element 51 is disposed above the radiating element 50. In this second variant, the parasitic element 51 is a three-dimensional volume shaped like a rounded cone 52 supported by a cylinder 53. The circular base of the cylinder 53 is located in a plane P″ parallel to the plane P of the radiating device formed by the arms 6 of the dipoles 4 as is shown in FIG. 5b. The diameter of the circular base is about 0.2 λₘᵢₙ where λₘᵢₙ is the wavelength of the lowest frequency fₘᵢₙ. The total height H of the parasitic element 51, meaning the cylinder topped with the rounded cone, is between 0.05 λ₀ and 0.25 λ₀, where λ₀ is the wavelength at the central operating frequency f₀.

FIGS. 6a and 6b illustrate a third variant of this first embodiment. FIG. 6a is a perspective view and FIG. 6b is a schematic cross-section view depicting how the planes overlap.

A radiating element 60 comprises dipoles 4 printed on a substrate 5 as described above. The arms 6 of the dipoles 4 constitute a radiating device disposed within a plane P parallel to the plane P′ of the reflector 3 as is shown schematically in FIG. 6b.

A parasitic element 61 is disposed above the radiating element 60. In this third variant, the three-dimensional parasitic element 61 is formed of four wings 62, each being shaped roughly like a clipped right triangle, which meet at right angles. The cross-shaped base of the parasitic element 61, defined by the long sides of the right triangles, is located within a plane P″ that is parallel to the plane P of the radiating device formed by the arms 6 of the dipoles 4. The peak 63, defined by the clipped angles of the right triangles is contained within a plane P″′ parallel to the plane P of the radiating device formed here by the arms 6 of the dipoles 4. The length of the long side of a right triangle is about 0.1 λₘᵢₙ where λₘᵢₙ is the wavelength of the lowest frequency fₘᵢₙ of the frequency band. The overall surface of the cross-shaped base is about 0.2 λₘᵢₙ×0.2 λₘᵢₙ. The height H of the parasitic element 61 is between 0.05 λ₀ and 0.25 λ₀, where λ₀ is the wavelength at the central operating frequency f₀.

A second embodiment is illustrated by FIGS. 7a and 7b. FIG. 7a is a perspective view and FIG. 7b is a schematic cross-section view depicting how the planes overlap.

A radiating element 70 comprises, on a reflector 71 equipped with side traps 72, a patch antenna 73, which is a flat antenna whose radiating device is a conductive surface separated from a conductive plane by a dielectric layer. The patch antenna 73, printed onto a dielectric substrate 74, is fed by electromagnetic coupling with a feedline 75 through crossing slots 76 built into a conductive mount serving as a ground plane 77 for the patch antenna 73. The feedline 75 of the microstrip type is printed onto a dielectric medium 78 and placed below the crossing slots 76. The patch antenna 73 constitutes a flat radiating device disposed within a plane P parallel to the plane P′ of the reflector 71 as shown schematically in FIG. 7b. The patch antenna 73 supported by the dielectric substrate 74 may be disposed as close as possible to the crossing slots 76 or separated from them by means of dielectric spacers, for example plastic columns.

A parasitic element 79 shaped like a truncated pyramid with a square base 80, similar to the one in FIG. 1a, is disposed above the patch antenna 73. The base 80 is contained within a plane P″ parallel to the plane P of the radiating device constituted by the patch antenna 73, and the truncated peak 81 is contained within a plane P″′ parallel to the plane P of the radiating device constituted here by the patch antenna 73 as is depicted schematically in FIG. 7b. In this variant, the side length of the square base 80 is about 0.2 λₘᵢₙ where λₘᵢₙ is the wavelength of the frequency band's lowest frequency fₘᵢₙ. The length of the side of the truncated peak 81 is about 0.2 λₘₐₓ where λₘₐₓ is the wavelength of the frequency band's highest frequency fₘₐₓ. The height H of the truncated pyramid-shaped parasitic element 9 is between 0.05 λ₀ and 0.25 λ₀, where λ₀ is the wavelength at the central operating frequency f₀.

We shall now consider FIGS. 8a and 8b, which illustrate a third embodiment FIG. 8a is a perspective view and FIG. 8b is a schematic cross-section view depicting how the planes overlap.

A radiating element 90, of the “butterfly” type, is fastened onto a reflector 91 and made of two dipoles 92, 93 with orthogonal cross-polarization ±45°. Each dipole 92, 93 comprises two arms 92a, 92b and 93a, 93b respectively, supported by a portion of the base 94. Each of the arms 92a, 92b and 93a, 93b forms a V, the arms 92a, 92b and 93a, 93b meet at the tip of the V. The arms 92a, 92b and 93a, 93b of the dipoles 92, 93 constitute of a radiating device disposed within a plane P parallel to the plane P′ of the reflector 91 as is depicted schematically in FIG. 8b.

A three-dimensional parasitic element 95 is disposed above the radiating element 90. The parasitic element 95 is made up of four wings 96a, 96b, 96c and 96d in three dimensions. The wings 96a-96d form truncated-pyramid sectors, with an angle of between 30° and 60°, connected at their tip and whose base is located within a plane parallel to the arms 92a, 92b, 93a, 93b of the dipoles 92, 93. The four wings 96a-96d define a square base whose side is about 0.2 λₘᵢₙ long, where λₘᵢₙ is the wavelength of the frequency band's lowest frequency fₘᵢₙ. The truncated ends of the wings 96a-96d define a peak whose side's length is about 0.2 λₘₐₓ, where λₘₐₓ is the wavelength of the frequency band's highest frequency fₘₐₓ. The height H of the parasitic element 95 is between 0.05 λ₀ and 0.25 λ₀, where λ₀ is the wavelength at the central operating frequency f₀.

Naturally, the present invention is not limited to the described embodiments, but is, rather, subject to many variants accessible to the person skilled in the art without departing from the spirit of the invention. In particular, it is possible without departing from the scope of the invention to alter the shape of the parasitic element's volume and to use any type of radiating element.

1. An antenna, intended to transmit and receive radio waves within a given frequency band, comprising
at least one radiating element placed on a flat reflector comprising a radiating device disposed within a plane P parallel to the plane P′ of the reflector,
at least one conductive line feeding the radiating element, and
at least one conductive parasitic element, disposed above the radiating element, comprising a two-dimensional base belonging to a plane P″ parallel to the plane P of the radiating device, associated with a third dimension that gives it a volumic shape.

2. An antenna according to claim 1, wherein the parasitic element is shaped like a truncated pyramid with a square base and a truncated peak.

3. An antenna according to claim 1, wherein the parasitic element is composed of four three-dimensional wings forming truncated-pyramid sectors, at an angle of between 30° and 60° inclusive, connected at their tip, the four wings defining a square base and a truncated peak.

4. An antenna according to claim 1, wherein the parasitic element is formed of four wings each having roughly the shape of a clipped right triangle, which meet at right angles, the cross-shaped base being defined by the long sides of the right triangles and the peak by the clipped angles.

5. An antenna according to claim 2, wherein the side length of the base is about 0.2 λₘᵢₙ, where λₘᵢₙ is the wavelength of the lowest frequency of the frequency band.

6. An antenna according to claim 2, wherein the length of the peak's side is about 0.2 λₘₐₓ, where λₘₐₓ is the wavelength of the highest frequency of the frequency band.

7. An antenna according to claim 1, wherein the parasitic element is shaped like a rounded cone supported by a cylinder.

8. An antenna according to claim 7, wherein the diameter of the circular base is about 0.2 λₘᵢₙ, where λₘᵢₙ is the wavelength of the lowest frequency of the frequency band.

9. An antenna according to claim 2, wherein the total height of the parasitic element is between 0.05 λ₀ and 0.25 λ₀ where λ₀ is the wavelength of the central operating frequency.

10. An antenna according to claim 1, wherein the distance separating the plane P″ of the parasitic element's base from the plane P of the radiating device is about 0.2 λ₀, where λ₀ is the wavelength at the central frequency of the frequency band.
